(19) United States
(12) Patent Application Publication
(10) Pub. No.: US 2025/0244991 A1
(43) Pub. Date: Jul. 31, 2025

(54) Processor Environment Architecture Agnostic Firmware Update Management Operation

(71) Applicant: Dell Products L.P., Round Rock, TX (US)

(72) Inventors: Gowrishankar Rudraprakash, Bengaluru (IN); Shekar Babu Suryanarayana, Bangalore (IN)

(21) Appl. No.: 18/429,068

(22) Filed: Jan. 31, 2024

(51) Int. Cl. G06F 8/65

(52) U.S. Cl. CPC G06F 8/65

(57) ABSTRACT

A firmware management operation. The firmware management operation includes providing an information handling system with a distributed BIOS; identifying a processor environment installed on an information handling system from a plurality of processor environments; performing a processor environment agnostic firmware update management operation, the processor environment agnostic firmware update management operation managing firmware updates associated with the plurality of processor environments.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed BIOS; identifying a processor environment installed on an information handling system from a plurality of processor environments; performing a processor environment agnostic firmware update management operation, the processor environment agnostic firmware update management operation managing firmware updates associated with the plurality of processor environments.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments; performing a processor environment agnostic firmware update management operation, the processor environment agnostic firmware update management operation managing firmware updates associated with the plurality of processor environments.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments; performing a processor environment agnostic firmware update management operation, the processor environment agnostic firmware update management operation managing firmware updates associated with the plurality of processor environments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of a processor environment agnostic firmware update management environment;

FIG. 6 is a simplified block diagram of a processor environment agnostic firmware update management system;

FIG. 7 is a simplified flow diagram of a platform firmware release catalog update operation; and

FIG. 8 is a simplified flow diagram of a processor environment agnostic firmware platform update management operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that often when a vulnerability is identified in a particular firmware version, a firmware update is released to address the vulnerability. Various aspects of the present disclosure include an appreciation that this firmware update is often referred to as a common vulnerability and exposure (CVE) firmware update. Various aspects of the invention reflect an appreciation that when a firmware update is released, firmware of respective information handling system architectures should be updated to include the firmware update. Various aspects of the invention reflect an appreciation that an information handling system firmware is a combination of many individual firmware modules from various vendors. Various aspects of the invention reflect an appreciation that these individual firmware modules can have various firmware update version dependencies across many different firmware updates. Various aspects of the invention reflect an appreciation that it would be desirable to generate one firmware release that addresses the interdependency of a plurality of firmware module updates.

Various aspects of the invention reflect an appreciation that when a firmware module update is released for a processor environment vulnerability, the processor environment provider often addresses the vulnerability and incorporates this revision into a firmware release. However, it can be challenging to identify various firmware update version dependencies across many different firmware updates.

Various aspects of the invention reflect an appreciation that firmware module updates often involve releasing multiple security updates to customers. Various aspects of the invention reflect an appreciation that releasing multiple security updates can require customers to perform firmware updates in a series. Various aspects of the invention reflect an appreciation that performing firmware updates in a series can require multiple reboots to the information handling system. Various aspects of the invention reflect an appreciation that performing multiple reboots to the information handling system reduces productivity time for the customer, resulting in a negative user experience.

Various aspects of the invention reflect an appreciation that with an information handling system there are often a plurality of component firmware modules. Various aspects of the invention reflect an appreciation that the plurality of component firmware module updates may be dependent on processor environment firmware module updates and these component firmware modules may also need to be upgraded. Various aspects of the present disclosure include an appreciation that when update is performed for a component firmware module without considering the update of dependent component firmware module update, the stability/security of the information handling system may be compromised. Various aspects of the invention reflect an appreciation that it would be desirable to provide a combined mechanism to manage component firmware module dependency updates such as security-based component firmware module dependency updates.

A system and method are disclosed for performing a processor environment agnostic firmware update management operation. In certain embodiments, a processor environment agnostic firmware update management system performs the processor environment agnostic firmware update management operation.

In certain embodiments, the processor environment agnostic firmware update management operation dynamically interpolates all reported firmware module updates for a particular information handling system platform and generates a single information handling system firmware update. In certain embodiments, the single information handling system firmware update is identified as a one uncompromised firmware (OUF) firmware update. In certain embodiments, the processor environment agnostic firmware update management operation uses a remote storage based location when dynamically interpolating all reported firmware module updates for a particular information handling system platform and generating a single information handling system firmware update. In certain embodiments, the remote storage based location includes a cloud based vulnerability chain accelerator (VCA) when dynamically interpolating all reported firmware module updates for a particular information handling system platform and generating a single information handling system firmware update. In certain embodiments, the processor environment agnostic firmware update management operation is provided as a service (AAS). In certain embodiments, the cloud based vulnerability chain accelerator is provided as a service.

In certain embodiments, the processor environment agnostic firmware update management operation uses a supervised learning module to continuously process identified vulnerabilities. In certain embodiments, the supervised learning module accesses a vulnerability management information catalog when continuously processing identified vulnerabilities. In certain embodiments, the vulnerability management information catalog identifies firmware modules impacted by a particular firmware security update. In certain embodiments, the vulnerability management information catalog identifies firmware modules impacted by a particular firmware security update for each of a plurality of different information handling system architectures. In certain embodiments, the plurality of different information handling system architectures can correspond to different lines of business within an information handling system supplier.

In certain embodiments, the processor environment agnostic firmware update management operation uses a synchronization protocol to access the vulnerability management information catalog. In certain embodiments, the synchronization protocol includes a smart predictive update synchronization (SPUS) protocol. In certain embodiments, the synchronization protocol performs a synchronization operation to access the vulnerability management information catalog. In certain embodiments, accessing the vulnerability management information catalog enables the processor environment agnostic firmware update management operation to determine which firmware module updates are necessary and to avoid firmware module updates which do not have a fully interpolated firmware module update array. In certain embodiments, the smart predictive update synchronization (SPUS) protocol ensures a customer receives a fully interpolated firmware module update array, thereby avoiding reboots from separately updating multiple firmware modules.

Such a processor environment agnostic firmware update management operation advantageously accelerates building a fully interpolated firmware module update array thereby reducing multiple updates for similar dependent firmware module updates. Providing the processor environment agnostic firmware update management operation with a vulnerability management information catalog advantageously expedites resolving fully interpolated firmware module update array for a plurality of different information handling system architectures. Providing the processor environment agnostic firmware update management operation with a synchronization protocol includes a smart predictive update synchronization protocol avoid reboots from separately updating multiple firmware modules.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

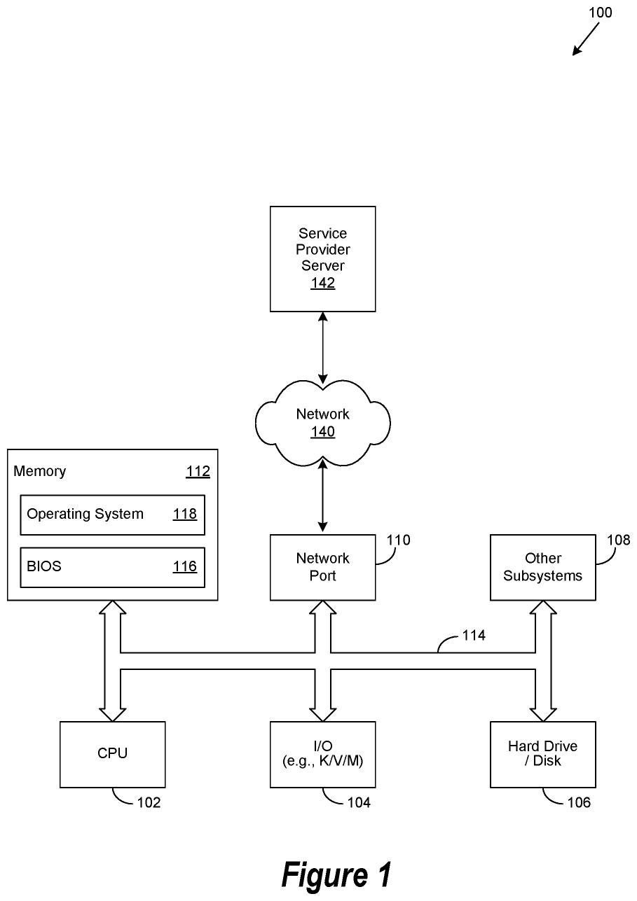

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, 5various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In certain embodiments, the firmware management operation may be performed during operation of an IHS 100. In various embodiments, performance of the firmware management operation may result in the realization of improved operation of an IHS 100.

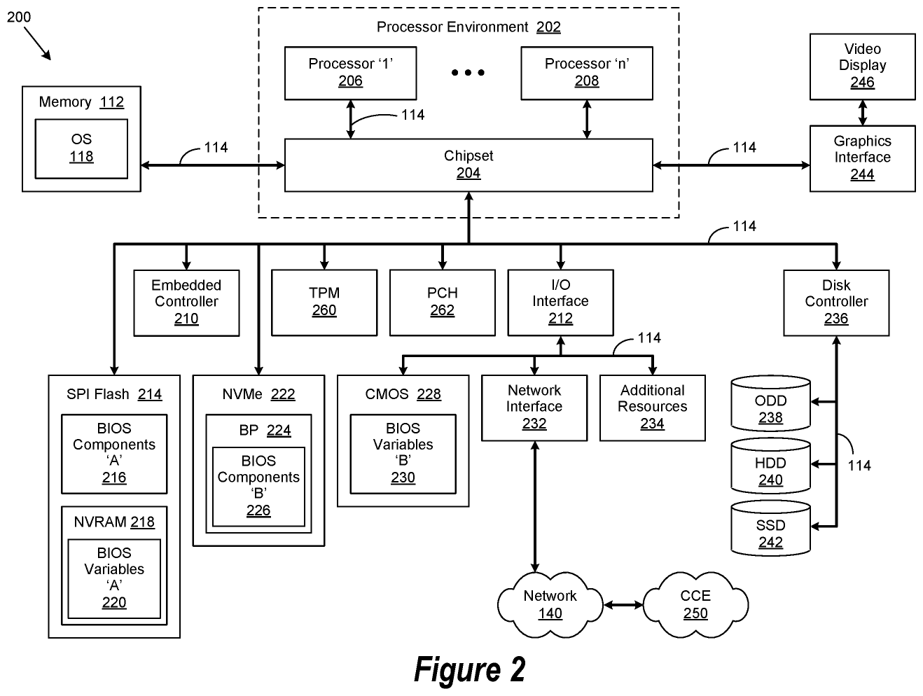

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an ARM type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux©.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

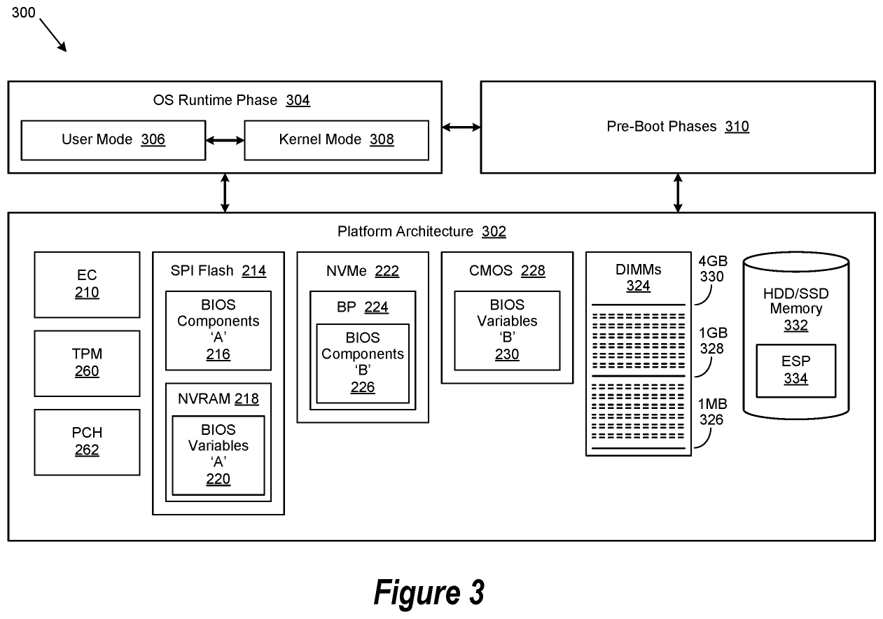

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel©, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it to control various data paths and support functions associated with a particular processor. Examples of such processors include those manufactured by Intel©, AMD®, Qualcom®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

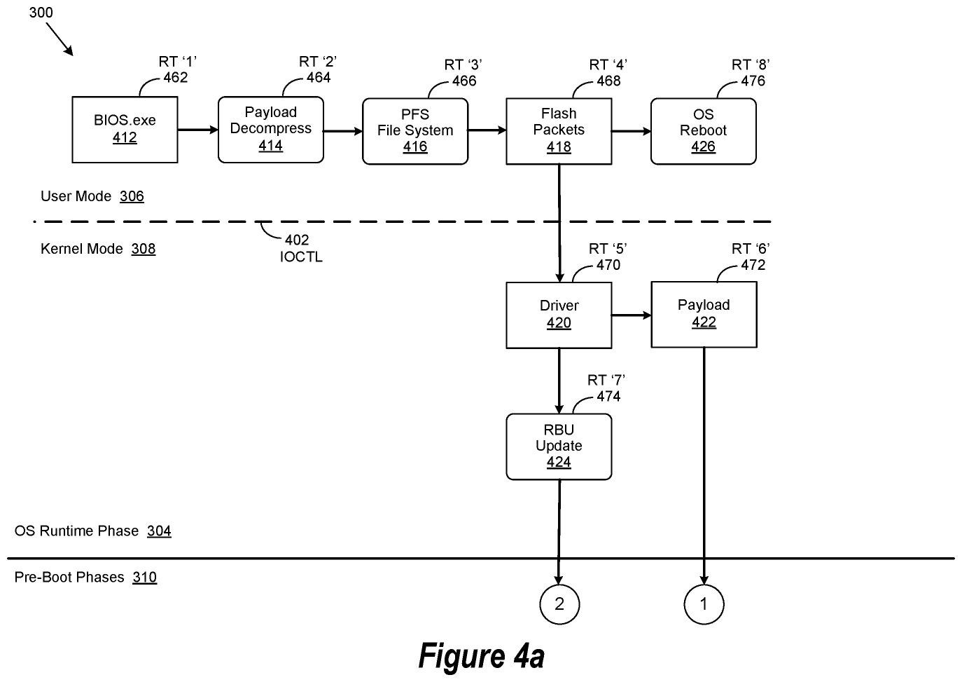

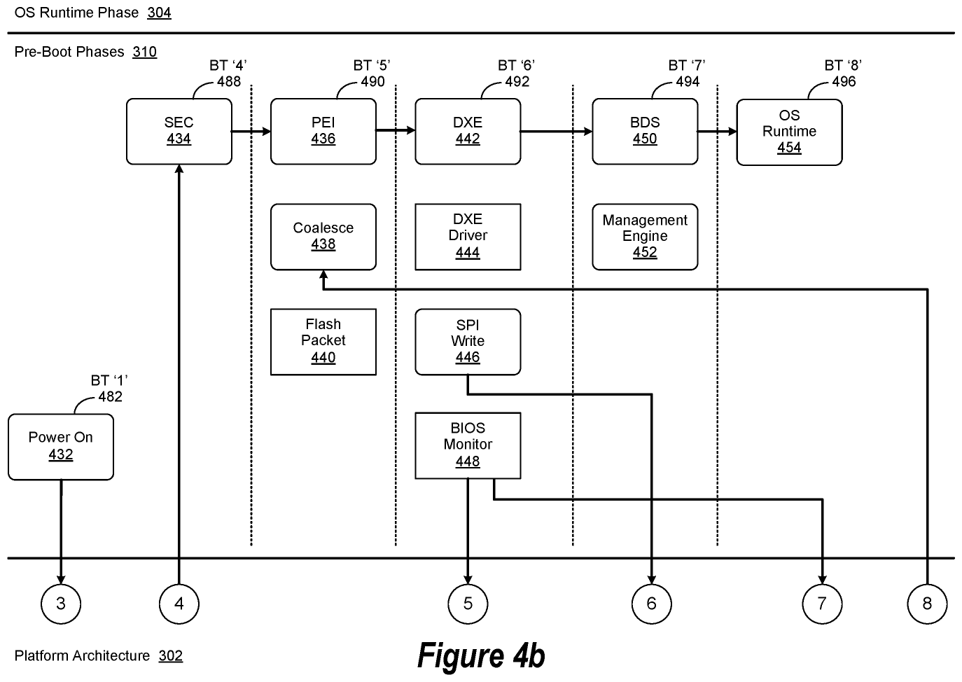

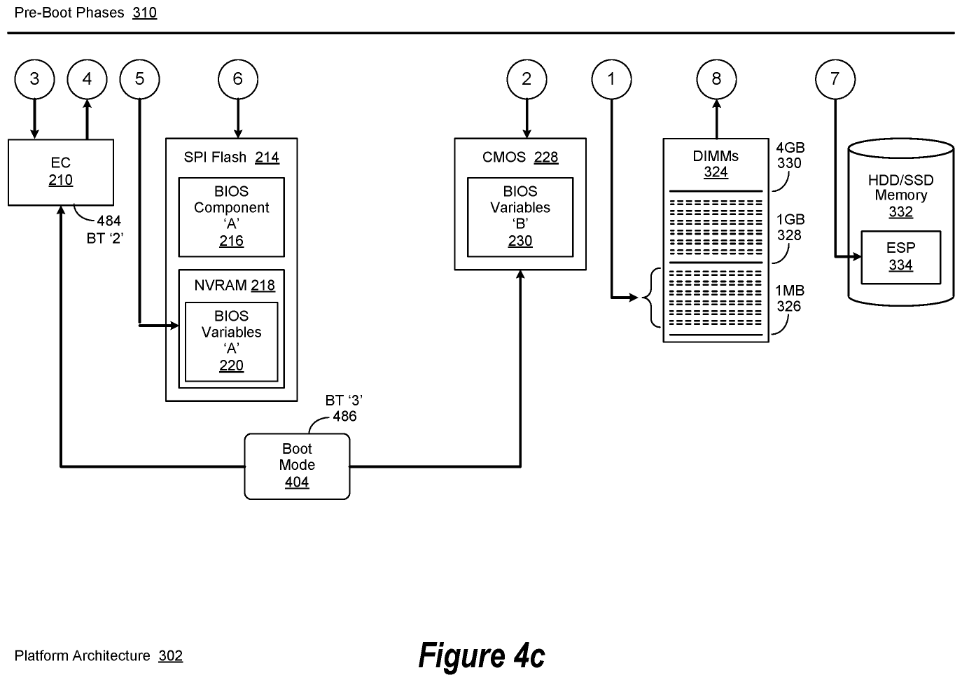

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

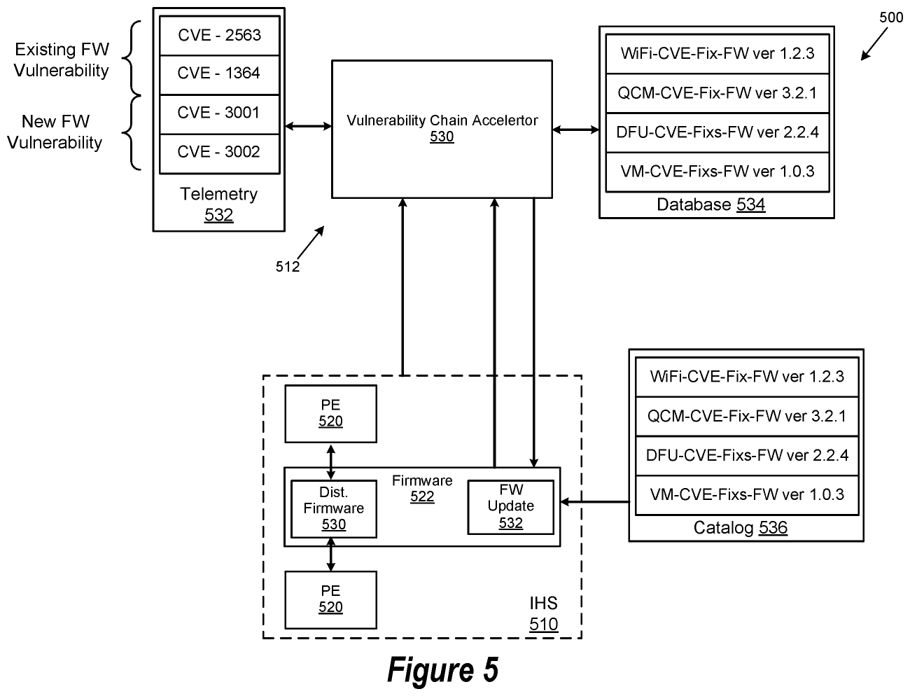

Referring to FIG. 5, a simplified block diagram of a processor environment agnostic firmware update management operation environment 500 is shown. In certain embodiments, the firmware management system may be implemented to perform a processor environment agnostic firmware update management operation. In various embodiments, a firmware management operation may be implemented to include a processor environment agnostic firmware update management operation.

In certain embodiments, the processor environment agnostic firmware update management operation is performed within the processor environment agnostic firmware update management environment 500. As used herein, a processor environment agnostic firmware update management operation broadly refers to a firmware management operation, described in greater detail herein, performed directly, or indirectly, within a multi-processor operating environment 200 to manage firmware updates associated with a plurality of processing environments. In certain embodiments, the managing the firmware associated with the plurality of processing environments includes managing an update process during which an information handling system is updated with a most recent firmware update. In certain embodiments, the most recent firmware update is provided to the information handling system via a fully interpolated firmware module update array. In certain embodiments, the managing the update process is performed during a pre-boot phase of operation.

In certain embodiments, the processor environment agnostic firmware update management environment 500 includes an information handling system 510, a remote storage portion 512, or a combination thereof. In certain embodiments, the information handling system 510 corresponds to information handling system 100, multi-processor operating environment 200, or a combination thereof. In certain embodiments, the combination of the information handling system 510 and the remote storage portion 512 provide a processor environment agnostic firmware update management system. In certain embodiments, a processor environment agnostic firmware update management system performs the processor environment agnostic firmware update management operation.

In certain embodiments, the information handling system 510 includes a processor environment 520, a firmware portion 522, a component portion 524, or a combination thereof. In certain embodiments, the firmware portion 522 includes a distributed firmware component 530, a system firmware update module 532, or a combination thereof. In certain embodiments, the distributed firmware portion comprises the distributed BIOS 116, the various BIOS components of multi-processing architecture 200, or a combination thereof. In certain embodiments, the component portion 524 comprises one or more of the various components of information handling system 100, the various components of the multi-processor operating environment 200, or a combination thereof.

In certain embodiments, the remote storage portion 512 includes a vulnerability chain accelerator 530, a vulnerability storage repository 532, a firmware component version update storage repository 534, a vulnerability management information catalog 536, or a combination thereof. In certain embodiments, the vulnerability chain accelerator 530 includes a cloud based vulnerability chain accelerator. In certain embodiments, the vulnerability chain accelerator 530 facilitates provision of processor environment agnostic firmware update management as a service. In certain embodiments, the vulnerability storage repository 532 includes entries for existing firmware vulnerabilities, new firmware vulnerabilities, or a combination thereof. In certain embodiments, the firmware component version update storage repository 534 includes entries for a plurality of firmware component updates. In various embodiments, the plurality of firmware component updates include updates associated with the processor environment 520 of the information handling system, the firmware portion 522 of the information handling system 510, the component portion 524 of the information handling system or a combination thereof. In certain embodiments, the plurality of firmware component updates includes BIOS component updates, BIOS variable updates, or a combination thereof. In certain embodiments, the vulnerability management information catalog 536 includes entries associated with a present version of one or more firmware components of the information handling system 510.

In certain embodiments, the processor environment agnostic firmware update management operation dynamically interpolates all reported firmware module updates for a particular information handling system platform and generates a single information handling system firmware update. In certain embodiments, the single information handling system firmware update is identified as a one uncompromised firmware (OUF) firmware update. In certain embodiments, the processor environment agnostic firmware update management operation uses a remote storage based location when dynamically interpolating all reported firmware module updates for a particular information handling system platform and generating a single information handling system firmware update. In certain embodiments, the remote storage based location includes a cloud based vulnerability chain accelerator when dynamically interpolating all reported firmware module updates for a particular information handling system platform and generating a single information handling system firmware update. In certain embodiments, the processor environment agnostic firmware update management operation is provided as a service (AAS). In certain embodiments, the cloud based vulnerability chain accelerator is provided as a service.

In certain embodiments, the processor environment agnostic firmware update management operation uses a supervised learning module to continuously process identified vulnerabilities. In certain embodiments, the supervised learning module accesses a vulnerability management information catalog when continuously processing identified vulnerabilities. In certain embodiments, the vulnerability management information catalog identifies firmware modules impacted by a particular firmware security update. In certain embodiments, the vulnerability management information catalog identifies firmware modules impacted by a particular firmware security update for each of a plurality of different information handling system architectures. In certain embodiments, the plurality of different information handling system architectures can correspond to different lines of business within an information handling system supplier.

In certain embodiments, the processor environment agnostic firmware update management operation uses a synchronization protocol to access the vulnerability management information catalog. In certain embodiments, the synchronization protocol includes a smart predictive update synchronization (SPUS) protocol. In certain embodiments, the synchronization protocol performs a synchronization operation to access the vulnerability management information catalog. In certain embodiments, accessing the vulnerability management information catalog enables the processor environment agnostic firmware update management operation to determine which firmware module updates are necessary and to avoid firmware module updates which do not have a fully interpolated firmware module update array. In certain embodiments, the smart predictive update synchronization protocol ensures a customer receives a fully interpolated firmware module update array, thereby avoiding reboots from separately updating multiple firmware modules.

In certain embodiments, the system firmware update module 532 executes a vulnerability remediation service. In certain embodiments, the vulnerability remediation service identifies and exports vulnerabilities within the platform to the vulnerability chain accelerator 530. In certain embodiments, the vulnerability chain accelerator 530 maintains a comprehensive database of vulnerabilities along with their corresponding fixed firmware versions. When a user initiates a firmware update on a similar platform, the platform sends its current firmware details to the vulnerability chain accelerator 530 and requests the latest firmware with fixes for the vulnerabilities. The vulnerability chain accelerator 530 validates, resolves dependencies, and sends the updated firmware back to the platform, ensuring the platform has the latest vulnerability fixes.

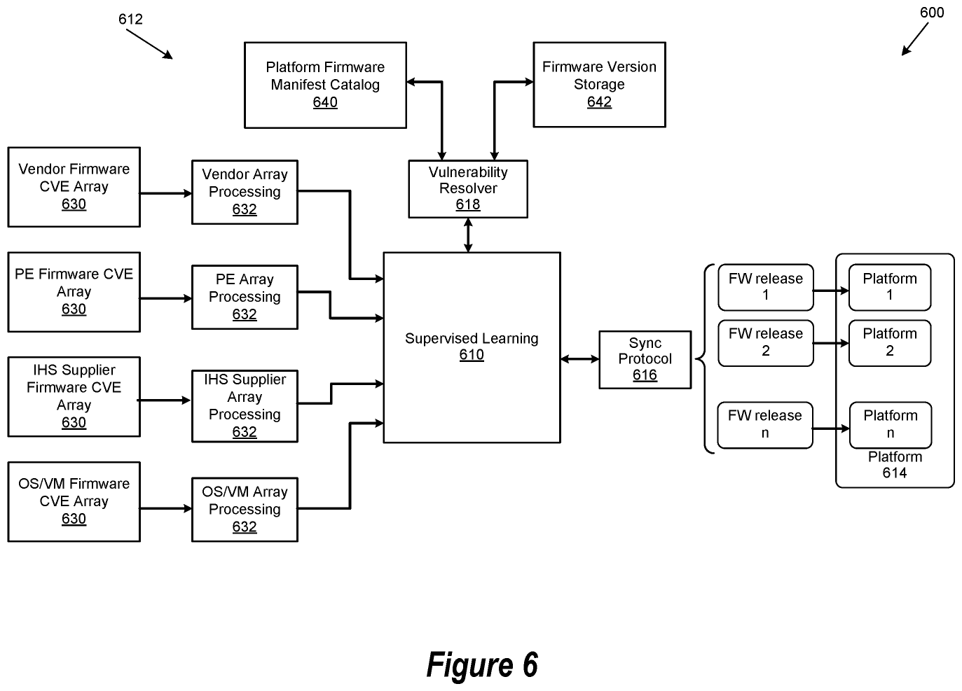

Referring to FIG. 6, a simplified block diagram of a processor environment agnostic firmware update management system 600 is shown. In certain embodiments, the processor environment agnostic firmware update management system 600 includes a supervised learning module 610, a storage portion 612, an information handling system platform portion 614, a synchronization protocol module 616, a vulnerability resolver module 618, or a combination thereof. In certain embodiments, each information handling system platform of the information handling system platform portion 614 corresponds to an information handling system 100, a multi-processor operating environment 200, or a combination thereof.

In certain embodiments, the storage portion 612 includes a plurality of common vulnerability and exposure arrays 630. In certain embodiments, each of the plurality common vulnerability and exposure arrays 630 include one or more specific common vulnerability and exposure array entries. In certain embodiments, the plurality of common vulnerability and exposure arrays 630 include a vendor firmware common vulnerability and exposure array, a processor environment firmware common vulnerability and exposure array, information handling system supplier firmware common vulnerability and exposure array, an operating system/virtual machine firmware common vulnerability and exposure array, or a combination thereof. In certain embodiments, the vendor firmware common vulnerability and exposure array includes one or more of a camera vulnerability and exposure entry, a WiFi vulnerability and exposure entry, an Ethernet vulnerability and exposure entry, a TMP vulnerability and exposure entry and a digital signal processor vulnerability and exposure entry. In certain embodiments, the processor environment firmware common vulnerability and exposure array includes one or more of a processor environment vulnerability and exposure entries, where each entry corresponds to a particular processor environment. In certain embodiments, the information handling system supplier firmware common vulnerability and exposure array includes one or more of a firmware update vulnerability and exposure entry, a print working directory firmware update vulnerability and exposure entry, a BIOS connect firmware update vulnerability and exposure entry, an SMBIOS firmware update vulnerability and exposure entry, and an NVMe firmware update vulnerability and exposure entry. In certain embodiments, the operating system/virtual machine firmware common vulnerability and exposure array includes one or more of a thermal driver firmware update vulnerability and exposure entry, a USB driver firmware update vulnerability and exposure entry, and a VM driver firmware update vulnerability and exposure entry.

In certain embodiments, the storage portion 612 includes a plurality of respective array processing components 632. In certain embodiments, each common vulnerability and exposure array 630 has an associated array processing component 632. In certain embodiments, the plurality of respective array processing components 632 include a vendor firmware common vulnerability and exposure array processing component, a processor environment firmware common vulnerability and exposure array processing component, information handling system supplier firmware common vulnerability and exposure array processing component, an operating system/virtual machine firmware common vulnerability and exposure array processing component, or a combination thereof. In certain embodiments each array processing component 632 processes an associated common vulnerability and exposure array 630 to identify vulnerabilities and exposures as well as dependencies across a plurality of array entries.

In certain embodiments, the storage portion 612 includes a platform firmware manifest catalog 640, a firmware version storage repository 642, or a combination thereof. In certain embodiments, the processor environment agnostic firmware update management system 600 uses the vulnerability resolver module 618 to provide a vulnerability chain accelerator which dynamically interpolates all reported firmware updates for a platform and recommends a single information handling system firmware update. As used herein, a vulnerability chain accelerator broadly a component which dynamically interpolates all reported firmware updates for a platform and recommends a single information handling system firmware update. In certain embodiments, the vulnerability chain accelerator module 618 executes at a remote location. In certain embodiments, the vulnerability chain accelerator module 618 comprises a cloud based vulnerability chain accelerator. In certain embodiments, the vulnerability chain accelerator module 618 is provided as a service. In certain embodiments, the processor environment agnostic firmware update management system 600 provides the cloud based vulnerability chain accelerator as a service. In certain embodiments, the single information handling system firmware update includes a fully interpolated firmware module update array. As used herein, a fully interpolated firmware module update array broadly refers to data structure which includes a collection of firmware module update components in which a single firmware release addresses any firmware module interdependencies associated with any of the plurality of firmware module update components.

In certain embodiments, the processor environment agnostic firmware update management system 600 uses the supervised learning module 610 to continuously process a vulnerability management information catalog to generate a firmware component impacted firmware catalog. In certain embodiments, the platform firmware manifest catalog 640 provides the firmware component impacted firmware catalog. In certain embodiments, a firmware component impacted firmware catalog is maintained for different information handling system platform architectures (e.g., Platform 1, Platform 2, . . . Platform N) provided by an information handling system supplier.

In certain embodiments, the supervised learning module 610 utilizes an artificial intelligence based supervised learning model which accesses vulnerability and exposure arrays from a plurality of sources. In certain embodiments, the plurality of vulnerability and exposure array processing components 632 transmit their respective vulnerability and exposure arrays to the vulnerability resolver module 618. In certain embodiments, each vulnerability and exposure array includes a plurality of entries. In certain embodiments, each entry includes a vulnerability and exposure identifier (ID), a description about the vulnerability, fix for the vulnerability, or a combination thereof. In certain embodiments, the vulnerability resolver module 618 provides a centralized database for all vulnerability and exposure arrays 630. In certain embodiments, the centralized database is maintained within the firmware version storage repository 642. In certain embodiments, the centralized database stores the arrays, their remedies, and the most recent fixed firmware versions from all information handling system modules. When performing a firmware management operation, the centralized database is referenced to collect the latest dependent firmware for specific information handling system architectures 650 thereby facilitating the execution of firmware updates. In certain embodiments, the firmware management operation performs updates based on predefined firmware maintenance procedures (FMP).

In certain embodiments, the processor environment agnostic firmware update management system 600 uses the synchronization protocol module 618 to obtain information from the vulnerability management information catalog. In certain embodiments, the synchronization protocol 618 utilizes a smart predictive update sync protocol to obtain information from the vulnerability management information catalog. In certain embodiments, the smart predictive update sync protocol performs a remote storage synchronization to access the vulnerability management information catalog. In certain embodiments, use of the smart predictive update sync protocol avoids updates which do not have a corresponding fully interpolated firmware module update array.

In certain embodiments, the synchronization protocol module 618 enables an information handling system platform to initiate synchronization with a cloud server before undergoing updates. In certain embodiments, the synchronization obtains the platform firmware manifest catalog 640. The synchronization protocol module 618 then compares an existing information handling system firmware module update array with a most recent firmware module update array. If the existing information handling system firmware module update array is already up-to-date or lacks the necessary updated data, the synchronization protocol module 618 skips updating that specific catalog and proceeds to the next firmware array. This approach guarantees that customers receive a finalized and rebuilt official update file (OUF), minimizing the need for multiple reboots to address the same vulnerability and exposure issues.

In certain embodiments, the synchronization protocol module 616 uses a synchronization protocol to access the vulnerability management information catalog. In certain embodiments, the synchronization protocol includes a smart predictive update synchronization (SPUS) protocol. In certain embodiments, the synchronization protocol performs a synchronization operation to access the vulnerability management information catalog. In certain embodiments, accessing the vulnerability management information catalog enables the processor environment agnostic firmware update management operation to determine which firmware module updates are necessary and to avoid firmware module updates which do not have a fully interpolated firmware module update array. In certain embodiments, the smart predictive update synchronization protocol ensures a customer receives a fully interpolated firmware module update array, thereby avoiding reboots from separately updating multiple firmware modules. In certain embodiments, the smart predictive update synchronization protocol provides a fully interpolated firmware module update array via respective platform specific firmware releases (FW release 1, FW release 2 . . . FW release n) to respective information handling system platforms.

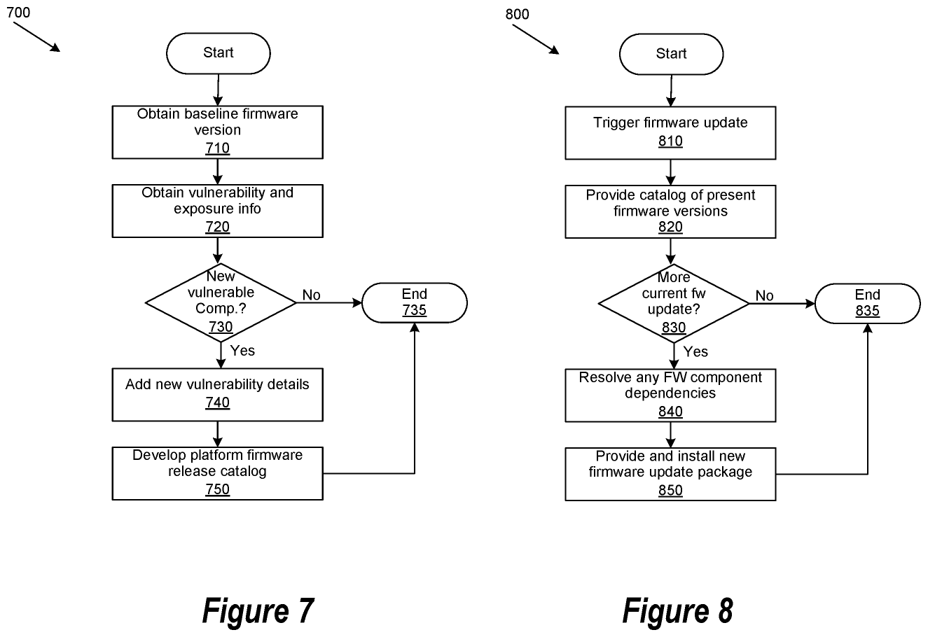

Referring to FIG. 7, a simplified flow diagram of a platform firmware release catalog update operation 700 is shown. In certain embodiments, a firmware management system may be implemented to perform the platform firmware release catalog update operation 700. In various embodiments, a processor environment agnostic firmware update management operation may be implemented to include a platform firmware release catalog update operation. As used herein, a platform firmware release catalog update operation broadly refers to a firmware management operation, described in greater detail herein, performed directly, or indirectly, within a multi-processor operating environment 200 to update one or more firmware components within a platform firmware release catalog.

More specifically, the platform firmware release catalog update operation 700 begins at step 710 by obtaining baseline firmware version from a plurality of firmware support sources. In certain embodiments, the plurality of firmware support sources includes one or more vulnerability and exposure arrays. Next at step 720, the processor environment agnostic firmware update management operation 700 obtains vulnerability and exposure information from the plurality of firmware support services. In certain embodiments, the vulnerability and exposure information includes information contained within the vulnerability and exposure arrays. Next at step 730, the platform firmware release catalog update operation 700 detects whether there are any new vulnerable components from any of the plurality of sources. In certain embodiments, a vulnerable component includes a firmware component for which a newer firmware update is available but not installed. In certain embodiments, a vulnerable component includes a firmware component for which a new vulnerability and exposure fix has been issued. If there are not any new vulnerable components, then execution completes at step 735.

If the information handling system does not have any new vulnerable components, then execution proceeds to step 740 during which the platform firmware release catalog update operation 700 adds the new vulnerability details to the vulnerability storage repository. Next at step 750, the platform firmware release catalog update operation 700 develops a platform firmware release catalog for one or more information handling system architectures. In certain embodiments, the platform firmware release catalog is included within vulnerability management information catalog and execution of the platform firmware release catalog update operation 700 completes at step 735.

Referring to FIG. 8, a simplified flow diagram of a processor environment agnostic platform firmware update management operation 800 is shown. In certain embodiments, a firmware management system may be implemented to perform the simplified flow diagram of a processor environment agnostic platform firmware update management operation 800. In various embodiments, a processor environment agnostic firmware update management operation may be implemented to include a simplified flow diagram of a processor environment agnostic platform firmware update management operation. As used herein, a simplified flow diagram of a processor environment agnostic platform firmware update management operation broadly refers to a firmware management operation, described in greater detail herein, performed directly, or indirectly, within a multi-processor operating environment 200 to update one or more firmware components of an information handling system platform.

More specifically, the simplified flow diagram of a processor environment agnostic platform firmware update management operation 800 begins at step 810 with a user triggering a firmware update for a particular information handling system platform. Next at step 820, the information handling system platform provides the processor environment agnostic firmware update management operation 800 with an existing catalog with a set of present firmware versions. Next at step 830, the processor environment agnostic platform firmware update management operation 800 determines whether there is a more current firmware update. In certain embodiments, the processor environment agnostic platform firmware update management operation 800 accesses a vulnerability chain accelerator when making the determination. In certain embodiments, a more current firmware update includes a firmware update for which a new vulnerability and exposure fix has been issued. If there are not any more current firmware updates, then execution completes at step 835.

If there is a more current firmware update available, then execution proceeds to step 840 during which the processor environment agnostic platform firmware update management operation 800 resolves any firmware component dependencies related to the more current firmware update. In certain embodiments, the vulnerability chain accelerator resolves the firmware component dependencies. In certain embodiments, the vulnerability chain accelerator adds the new vulnerability details to the vulnerability storage repository. Next at step 850, the processor environment agnostic platform firmware update management operation 800 provides and installs a new firmware update package to the information handling system and execution completes at step 835. In certain embodiments, the new firmware update is provided via a latest fixed firmware package. In certain embodiments, the latest fixed firmware package includes a fully interpolated firmware module update array.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed BIOS;
identifying a processor environment installed on an information handling system from a plurality of processor environments;
performing a processor environment agnostic firmware update management operation, the processor environment agnostic firmware update management operation managing firmware updates associated with the plurality of processor environments.

2. The method of claim 1, wherein:
the information handling system includes an information handling system platform architecture; and,
the processor environment agnostic firmware update management operation manages firmware updates associated with at least one component of the information handling system platform architecture.

3. The method of claim 1, wherein:
the processor environment agnostic firmware update management operation accesses a remote storage location when managing firmware updates associated with the plurality of processor environments.

4. The method of claim 3, wherein:
the remote storage location maintains a catalog of a plurality of firmware component updates.

5. The method of claim 1, wherein:
the processor environment agnostic firmware update management operation accesses a vulnerability chain accelerator when managing firmware updates, the vulnerability chain accelerator dynamically interpolates all reported firmware updates for a platform and recommends a single information handling system firmware update.

6. The method of claim 5, wherein:
the single information handling system update is provided to the information handling system via a fully interpolated firmware module update array.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS;
identifying a processor environment installed on an information handling system from a plurality of processor environments;
performing a processor environment agnostic firmware update management operation, the processor environment agnostic firmware update management operation managing firmware updates associated with the plurality of processor environments.

8. The system of claim 7, wherein:
the information handling system includes an information handling system platform architecture; and,
the processor environment agnostic firmware update management operation manages firmware updates associated with at least one component of the information handling system platform architecture.

9. The system of claim 7, wherein:
the processor environment agnostic firmware update management operation accesses a remote storage location when managing firmware updates associated with the plurality of processor environments.

10. The system of claim 9, wherein:
the remote storage location maintains a catalog of a plurality of firmware component updates.

11. The system of claim 7, wherein:
the processor environment agnostic firmware update management operation accesses a vulnerability chain accelerator when managing firmware updates, the vulnerability chain accelerator dynamically interpolates all reported firmware updates for a platform and recommends a single information handling system firmware update.

12. The system of claim 11, wherein:
the single information handling system update is provided to the information handling system via a fully interpolated firmware module update array.

13. A non-transitory, computer-readable storage medium embodying computer program code, the computer program code comprising computer executable instructions configured for:
providing an information handling system with a distributed BIOS;
identifying a processor environment installed on an information handling system from a plurality of processor environments;
performing a processor environment agnostic firmware update management operation, the processor environment agnostic firmware update management operation managing firmware updates associated with the plurality of processor environments.

14. The non-transitory, computer-readable storage medium of claim 13, wherein:
the information handling system includes an information handling system platform architecture; and,
the processor environment agnostic firmware update management operation manages firmware updates associated with at least one component of the information handling system platform architecture.

15. The non-transitory, computer-readable storage medium of claim 13, wherein:
the processor environment agnostic firmware update management operation accesses a remote storage location when managing firmware updates associated with the plurality of processor environments.

16. The non-transitory, computer-readable storage medium of claim 15, wherein:
the remote storage location maintains a catalog of a plurality of firmware component updates.

17. The non-transitory, computer-readable storage medium of claim 16, wherein:
the processor environment agnostic firmware update management operation accesses a vulnerability chain accelerator when managing firmware updates, the vulnerability chain accelerator dynamically interpolates all reported firmware updates for a platform and recommends a single information handling system firmware update.

18. The non-transitory, computer-readable storage medium of claim 17, wherein:
the single information handling system update is provided to the information handling system via a fully interpolated firmware module update array.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
